(19) United States
(12) Patent Application Publication
(10) Pub. No.: US 2026/0003204 A1
(43) Pub. Date: Jan. 1, 2026

(54) ACCESSORY, CONTROL METHOD, AND STORAGE MEDIUM

(71) Applicant: CANON KABUSHIKI KAISHA, Tokyo (JP)

(72) Inventor: NAOKI SAITO, Tochigi (JP)

(21) Appl. No.: 19/251,521

(22) Filed: Jun. 26, 2025

(30) Foreign Application Priority Data
Jul. 1, 2024 (JP) 2024-105942

(51) Int. Cl. G02B 27/64

(52) U.S. Cl. CPC G02B 27/646

(57) ABSTRACT

An accessory for use with an image pickup apparatus includes a first drive unit for moving a first movable member, a second drive unit for moving a second movable member, one or more memories storing instructions, and one or more processors that, upon execution of the instructions, operate to control power used for driving the first drive unit and the second drive unit. In a case where an orientation of the accessory changes from a first orientation to a second orientation, power used for driving one of the first drive unit or the second drive unit increases while power used for driving the other of the first drive unit and the second drive unit decreases. The one or more processors operate to change an upper limit value of the power used for driving the first drive unit and second drive unit based on the orientation of the accessory.

### BACKGROUND

### Field of the Technology

The present disclosure relates to one or more embodiments of an accessory, such as a lens apparatus for use with an image pickup apparatus.

### Description of the Related Art

In a lens apparatus, movable members such as an aperture stop, an image stabilizing lens, a focus lens, and a zoom lens are often electrically and simultaneously driven. The lens apparatus receives power from an image pickup apparatus to which it is attached to drive these movable members, but available power amount is typically limited.

Japanese Patent Application Laid-Open No. 2006-189506 discloses a lens apparatus that drives a lens in a power-saving mode in a case where the lens apparatus is in a horizontal orientation and requires less power to drive the lens that is movable in the optical axis direction, and drives the lens in a normal mode in a case where the lens apparatus is in a vertical orientation and requires more power to drive the lens. Japanese Patent No. 6746014 discloses an image pickup apparatus that reduces a total power amount that can be supplied to a plurality of drive units in a case where the total power amount decreases, while maintaining a ratio of the power amounts supplied to the plurality of drive units.

### SUMMARY

One or more embodiments of an accessory for use with an image pickup apparatus according to one or more aspects of the present disclosure comprises a first drive unit configured to move a first movable member, a second drive unit configured to move a second movable member, one or more memories storing instructions, and one or more processors that, upon execution of the instructions, operate to control power used for driving the first drive unit and the second drive unit. In a case where an orientation of the accessory changes from a first orientation to a second orientation, power used for driving one of the first drive unit or the second drive unit increases while power used for driving the other of the first drive unit or the second drive unit decreases. The one or more processors operate to change an upper limit value of the power used for driving the first drive unit and the second drive unit based on the orientation of the accessory.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of an imaging system according to one or more embodiments of the present disclosure.

FIGS. 2A, 2B, and 2C illustrate a variety of orientations of the imaging system according to one or more embodiments of the present disclosure.

FIGS. 3A and 3B illustrate the conventional upper limit values of the power.

FIGS. 4A and 4B illustrate upper limit values of the power according to a comparative example.

FIGS. 5A and 5B illustrate upper limit values of the power according to one or more embodiments of the present disclosure.

FIGS. 6A and 6B illustrate the surplus power distribution in one or more embodiments of the present disclosure.

FIG. 7 is a flowchart illustrating processing of setting an upper limit of the power according to one or more embodiments of the present disclosure.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the present disclosure.

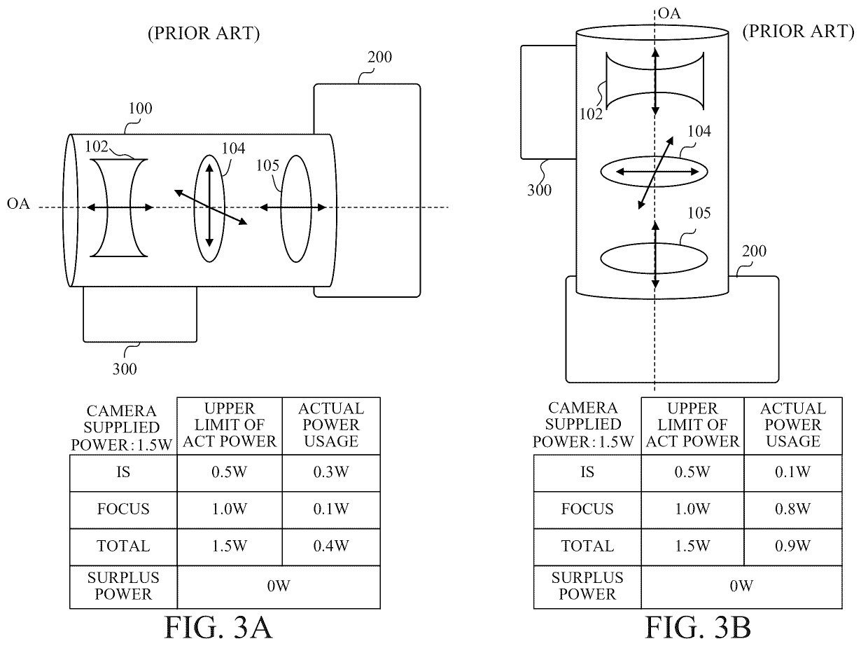

Referring to FIGS. 3A and 3B, a description will now be provided of the conventional upper limit values of the power of the image stabilizing actuator 110 and the focus actuator 112. FIGS. 3A and 3B respectively illustrate examples of the upper limit values of the power and their total value for the image stabilizing actuator 110 and the focus actuator 112 in the horizontal and vertical orientations. FIGS. 3A and 3B also illustrate examples of the actual power consumption and the total value for the image stabilizing actuator 110 and the focus actuator 112.

As described above, the actual power consumption for the image stabilizing actuator 110 and the focus actuator 112 changes based on the orientation of the imaging system. The suppliable power from the camera body 200 to the interchangeable lens 100 and the adapter 300 is predetermined and limited. Thus, the power upper-limit setting unit 122 sets an upper limit value of the power for the power to be distributed to the multiple actuators in the interchangeable lens 100 and the adapter 300.

One power distributing method for keeping the upper limit value of the power is, for example, to set the PWM duty ratio notified from the lens CPU 114 to each drive circuit at or below a predetermined value. In a case where the PWM duty ratio is limited, the effective voltage when the actuator is driven is lowered, and thereby power consumption is limited. Based on the orientation change of the imaging system, the actual power consumption of the image stabilizing actuator 110 is maximized at the horizontal orientation illustrated in FIG. 3A, and the actual power consumption of the focus actuator 112 is maximized at the vertical orientation (upward orientation) illustrated in FIG. 3B.

A general method sets an upper limit of the power based on the maximum value of the actual power consumption for each actuator, and distributes the power supplied to these actuators. This method does not change the upper limit value of the power based on the orientation, but always keeps it constant. For example, assume that the suppliable power from the camera body 200 to the interchangeable lens 100 is set to 1.5 W. In a case where the power to be used by actuators other than the image stabilizing actuator 110 and the focus actuator 112, such as the lens CPU 114, and each driving circuit, are not considered, the upper limit value of the power for the image stabilizing actuator 110 is set to 0.5 W, and the upper limit value of the power for the focus actuator 112 is set to 1 W.

The actual power usage for this upper limit value of the power is, for example, 0.3 W for the image stabilizing actuator 110 and 0.1 W for the focus actuator 112 in the horizontal orientation, for a total of 0.4 W. The total value of 0.4 W is lower than 1.5 W by 1.1 W. In the vertical orientation, the image stabilizing actuator 110 is 0.1 W and the focus actuator 112 is 0.8 W, for a total of 0.9 W. While the total value of 0.9 W is more than that of the horizontal orientation, it is lower than the supplied power of 1.5 W from the camera body 200 by 0.6 W.

The fixed upper limit value of the power of 1.5 W for the image stabilizing actuator 110 and the focus actuator 112 is the same as the supplied power of 1.5 W from the camera body 200. Therefore, even though the actual power usage has a margin above the upper limit value of the power as described above, no surplus power can be secured that can be supplied to other components in the interchangeable lens 100 (and other operation units for operating them: actuators and circuits) or the adapter 300.

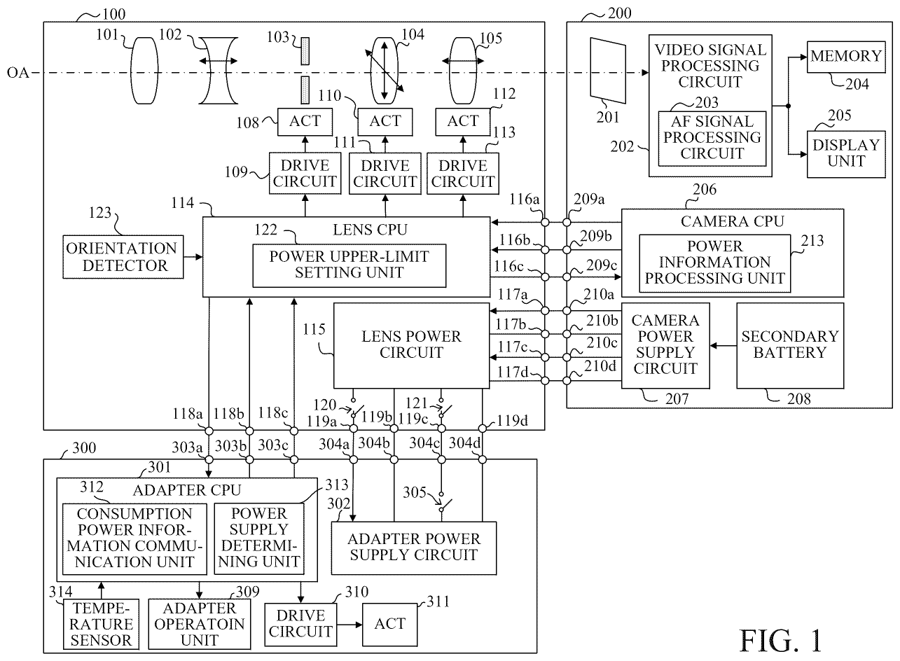

FIG. 1 illustrates the configuration of an imaging system that includes an interchangeable lens (lens apparatus) 100 as an accessory according to the embodiment, and a camera body 200 as an image pickup apparatus to which the interchangeable lens 100 is detachably attached. The interchangeable lens 100 is attached to an adapter 300 as an accessory that performs zooming by rotating a zoom operation ring (not illustrated) provided on the interchangeable lens 100 from the outside of the interchangeable lens 100.

The interchangeable lens 100 includes an imaging optical system. The imaging optical system includes, in order from the object side (left side of the figure), a fixed front lens 101, a magnification-varying lens 102, an aperture stop 103, an image stabilizing lens 104, and a focus lens 105. Each lens includes one or more lens elements.

The magnification-varying lens 102 performs magnification variation (zooming) by moving to a telephoto side and a wide-angle side in the optical axis direction (first direction) that is a direction along an optical axis OA. In the present embodiment, the magnification-varying lens 102 moves in the optical axis direction in a case where a zoom ring (not illustrated) is rotated by a user or driven by the adapter 300.

The aperture stop 103 adjusts a light amount by changing an aperture diameter using an aperture actuator 108 including a stepping motor, DC motor, or the like. An aperture drive circuit 109 supplies a drive voltage and a drive current to the aperture actuator 108.

The image stabilizing lens (first movable member) 104 moves in a direction orthogonal to the optical axis direction (second direction) using an image stabilizing actuator (first drive unit) 110 that includes a voice coil motor (VCM) to reduce (correct) image blur caused by camera shake, such as hand shake. An image stabilizing drive circuit 111 supplies a drive voltage and a drive current to the image stabilizing actuator 110. The VCM as the image stabilizing actuator 110 includes a drive coil and a magnet (not illustrated), and when a current flows through the drive coil in the magnetic field of the magnet, the image stabilizing lens 104 is shifted in a plane orthogonal to the optical axis direction or rotated around a point on the optical axis OA.

The focus lens (second movable member) 105 is driven in the optical axis direction by a focus actuator (second drive unit) 112 including a VCM to perform focusing. A focus drive circuit 113 supplies a drive voltage and a drive current to the focus actuator 112. The VCM as the focus actuator 112 includes a drive coil and a magnet (not illustrated), and when a current flows through the drive coil in the magnetic field of the magnet, the focus lens 105 is driven to an infinity side and a close distance side in the optical axis direction. The focus actuator 112 may be composed of a stepping motor or a vibration type motor.

The image stabilizing drive circuit 111 and focus drive circuit 113 drive the image stabilizing actuator 110 and focus actuator 112 by a pulse width modulation (PWM) method. The lens CPU 114, which serves as a controller, sends control signals to the image stabilizing drive circuit 111 and focus drive circuit 113 to notify (instruct) the PWM duty ratio. Each drive circuit drives each actuator at a PWM duty ratio corresponding to the received control signal.

An orientation detector 123 includes an acceleration sensor, detects the orientation (or attitude) of the imaging system, and outputs a signal indicating the orientation to the lens CPU 114.

The interchangeable lens 100 includes electrical contacts 116a, 116b, and 116c, which are electrically connectable to electrical contacts 209a, 209b, and 209c provided on the camera body 200, respectively. This enables various information to be communicated between the lens CPU 114 and the camera CPU 206 provided in the camera body 200. In the present embodiment, the lens CPU 114 and the camera CPU 206 perform three-wire serial communication with the camera CPU 206 as the clock master. However, another communication method may be used.

In a case where the adapter 300 is attached to the interchangeable lens 100, the electrical contacts 118a, 118b, and 118c provided in the interchangeable lens 100 are electrically connected to the electrical contacts 303a, 303b, and 303c provided in the adapter 300, respectively. Thus, various information can be communicated between the lens CPU 114 and the adapter CPU 301 provided in the adapter 300. In the present embodiment, the lens CPU 114 and the adapter CPU 301 perform three-wire serial communication with the lens CPU 114 as the clock master. However, another communication method may be used.

The interchangeable lens 100 stores, as its unique information, identification information, optical information (such as focal length, aperture value (F-number), focus sensitivity, and focus correction amount), and characteristic information (such as a maximum communication speed, a maximum F-number, whether zoom is possible, whether autofocus (AF) is possible, and a power mode). The interchangeable lens 100 transmits this information to the camera body 200. In a case where the adapter 300 is attached to the interchangeable lens 100, characteristic information of the adapter 300 (zoom drive speed, maximum communication speed, etc.) is transmitted to the camera body 200 via the interchangeable lens 100. The interchangeable lens 100 also receives identification information, power consumption information, etc. from the attached adapter 300.

Power contacts 117a, 117b, 117c, and 117d provided on the interchangeable lens 100 are electrically connectable to power contacts 210a, 210b, 210c, and 210d provided on the camera body 200, respectively. As a result, power is supplied to the interchangeable lens 100 from the camera body 200. Power may be supplied to the interchangeable lens 100 from an external power source other than the camera body 200. Power contacts 119a, 119b, 119c, and 119d provided on the interchangeable lens 100 are electrically connectable to power contacts 304a, 304b, 304c, and 304d provided on the adapter 300, respectively. Thus, power can be supplied from the interchangeable lens 100 to the adapter 300. In other words, power is supplied from the camera body 200 to the adapter 300 via the interchangeable lens 100.

The power contacts 117a, 210a, 119a, and 304a are system power terminals for supplying power to a variety of sensors (not illustrated), the lens CPU 114, the adapter CPU 301, and the adapter operation unit 309. The power contacts 117b, 210b, 119b, and 304b are ground terminals for the system power terminals. The power contacts 117c, 210c, 119c, and 304c are power supply terminals that supply power to each drive circuit, and the power contacts 117d, 210d, 119d, and 304d are ground terminals for the power supply terminals. The camera body 200 includes a secondary battery 208, such as a lithium ion battery, and power converted to a predetermined voltage by a camera power supply circuit 207 such as a DC-DC converter, is supplied to the interchangeable lens 100 and the adapter 300.

A lens power supply circuit 115 provided in the interchangeable lens 100 is a power conversion circuit, such as a DC-DC converter, converts the power supplied from the camera body 200 to power of a voltage for a variety of sensors and drive circuits, and distributes it to them. An adapter power supply circuit 302 provided in the adapter 300 is a power conversion circuit, such as a DC-DC converter, and converts the power supplied from the camera body 200 via the power contacts of the interchangeable lens 100 to power of a voltage for a variety of sensors and drive circuits, and distributes it to them.

When the adapter 300 is attached to the interchangeable lens 100 while the interchangeable lens 100 is attached to the camera body 200, the lens CPU 114 controls turning on and off the system power control switch 120 and the power control switch 121 in the interchangeable lens 100. Thus, power can be supplied to the adapter 300 at a proper timing. At the same time, in the adapter 300, the adapter CPU 301 controls turning on and off the power control switch 305. Thus, power can be supplied to the drive circuit 310 and the zoom actuator 311 at a proper timing.

The camera body 200 has an image sensor 201 as a photoelectric conversion element, such as a CMOS sensor. The image sensor 201 photoelectrically converts an optical image (object image) formed on its imaging surface by the imaging optical system. The charge accumulated in the image sensor 201 by photoelectric conversion is output as an imaging signal (analog signal) at a predetermined timing, and the imaging signal is input into a video signal processing circuit 202.

The video signal processing circuit 202 converts the analog image signal from the image sensor 201 into a digital image signal, and performs various signal processing such as amplification and gamma correction for the digital image signal to generate a video signal. The video signal is output to the camera CPU 206, a display unit 205 including a liquid crystal panel or the like, and a memory 204 including an optical disc, semiconductor memory, or the like.

The video signal processing circuit 202 has an AF signal processing circuit 203. The AF signal processing circuit 203 extracts high-frequency components and luminance components obtained by a group of pixels in the AF area, which is a focus detecting area, from the image signal (or video signal) output from the image sensor 201 to generate a focus evaluation signal. The focus evaluation signal indicates the contrast state of the video signal, that is, the sharpness, and changes with the movement of the focus lens 105. A position of the focus lens 105 that maximizes (provides a peak to) a value of the focus evaluation signal, that is, a focus evaluation value is an in-focus position.

The camera CPU 206 has a power information processing unit 213. The power information processing unit 213 performs, based on the power consumption information received from the lens CPU 114, efficient power management by changing the settings of the power supply to the interchangeable lens 100 and the adapter 300 and the settings of the imageable resolution and frame rate.

The lens CPU 114 has a power upper-limit setting unit 122. The power upper-limit setting unit 122 determines a power supply amount to the adapter 300 based on the power consumption information received from the adapter CPU 301, and determines, based on the power supply amount, the upper limit value of the power of the interchangeable lens 100 while the adapter 300 is connected.

Upper limit values of the power in the present embodiment include an upper limit value of the available power to drive the image stabilizing actuator 110, an upper limit value of the available power to drive the focus actuator 112, and a total value of them. In the following description, the power that is actually used to drive the image stabilizing actuator 110 will be referred to as the actual power usage by the image stabilizing actuator 110, and the power that is actually used to drive the focus actuator 112 will be referred to as the actual power usage by the focus actuator 112. The driving of the image stabilizing actuator 110, as used herein, includes operations of the lens CPU 114 that controls the driving of the image stabilizing actuator 110 and the image stabilizing drive circuit 116. Similarly, the driving of the focus actuator 112 includes operations of the lens CPU 114 that controls the driving of the focus actuator 112 and the focus drive circuit 113.

The upper limit value of the power set by the power upper-limit setting unit 122 is sent from the lens CPU 114 to the camera CPU 206. Even if the adapter 300 is not connected to the interchangeable lens 100, the lens CPU 114 sends the upper limit value of the power of the interchangeable lens 100 to the camera body 200.

The adapter CPU 301 has a power consumption information communication unit 312 and a power supply determining unit 313. The power supply determining unit 313 determines whether an external power supply for the adapter is connected to a power connector (not illustrated) and whether power is being supplied. By supplying power directly from the external power supply for the adapter, there is no upper limit on the power supply even if the required power changes due to changes in orientation or temperature, so there is no impact on the drive. That is, it is determined whether power supplied from the camera body 200 via the interchangeable lens 100 is necessary, and based on the determination result, the power consumption information communication unit 312 transmits information about the power consumption of the adapter 300 to the lens CPU 114. A temperature sensor (temperature detector) 314 notifies the adapter CPU 301 of the detected temperature. The adapter CPU 301 notifies the lens CPU 114 of the detected temperature.

The adapter operation unit 309 provided in the adapter 300 detects a zoom operation by a user. The adapter CPU 301 outputs a control signal to the drive circuit 310 based on the detected zoom operation, and the drive circuit 310 drives the zoom actuator 311 based on the control signal. The zoom actuator 311 rotates and drives the zoom operation ring of the interchangeable lens 100 via a gear train (not illustrated). Thus, electric zoom of the interchangeable lens 100 can be achieved.

The present embodiment changes the PWM duty ratio for driving the image stabilizing actuator 110 and the focus actuator 112 based on the orientation of the interchangeable lens 100 (imaging system) detected by the orientation detector 123. Here, values added to the PWM duty ratio based on the orientation are retaining addition amounts. A larger one of the values of the retaining addition amounts is set to “1” and a smaller one of the values is set to “0.”

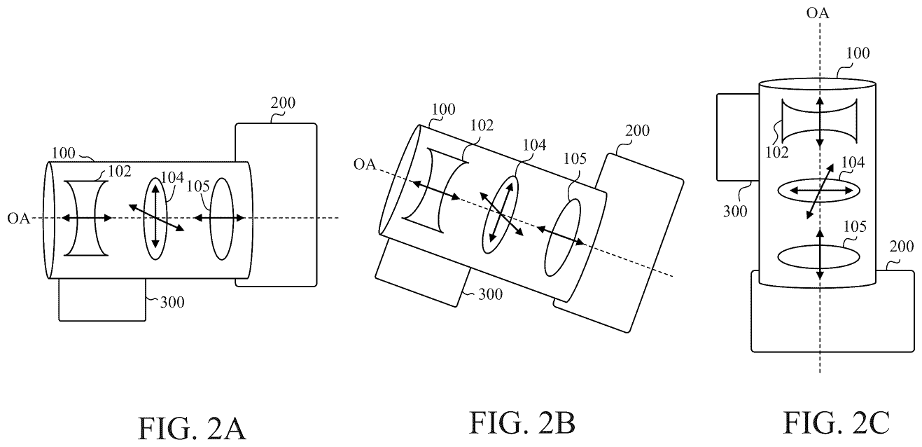

FIGS. 2A, 2B, and 2C illustrate a variety of orientations of the imaging system. In a case where the imaging system has the horizontal orientation illustrated in FIG. 2A, it is necessary to retain the image stabilizing lens 104 at a neutral position on the optical axis OA against gravity. At this time, in order to prevent the image stabilizing lens 104 from moving downward due to its own weight, the retaining addition amount for the image stabilizing actuator 110 is set to “1.”

In a case where the imaging system changes from the horizontal orientation to a diagonally upward orientation (or diagonally downward orientation) as illustrated in FIG. 2B, the retaining addition amount for the image stabilizing actuator 110 is reduced compared with that for the horizontal orientation in order to prevent downward movement due to a part of the weight of the image stabilizing lens 104. Then, in a case where the imaging system has a vertical orientation (upward or downward orientation), as illustrated in FIG. 2C, it is no longer necessary to prevent downward movement due to the weight of the image stabilizing lens 104, so the retaining addition amount for the image stabilizing actuator 110 is set to “0.”

For the focus lens 105, in a case where the orientation of the imaging system has the horizontal orientation as illustrated in FIG. 2A, it is no longer necessary to prevent downward movement due to its weight, so the retaining addition amount for the focus actuator 112 is set to “0.” In a case where the imaging system changes from a horizontal orientation to a diagonally upward orientation, as illustrated in FIG. 2B, the retaining addition amount for the focus actuator 112 is made larger than the horizontal orientation to prevent downward movement due to a portion of the weight. Then, in a case where the imaging system reaches a vertical orientation as illustrated in FIG. 2C, the retaining addition amount for the focus actuator 112 is set to “1” to prevent downward movement due to the weight of the focus lens 105.

By controlling the retention addition amount in this way, the actual power usage (power consumption) of the image stabilizing actuator 110 decreases and the actual power usage of the focus actuator 112 increases based on the orientation change from the horizontal orientation (first orientation) to the vertical orientation (second orientation). The total actual power usage of the image stabilizing actuator 110 and the focus actuator 112 changes based on the orientation change.

In the present embodiment, the actual power usages of the image stabilizing actuator 110 and the focus actuator 112 change based on the orientation, and the upper limit value of the power changes based on the actual power usage that changes based on the orientation. The surplus power, which is a difference between the power supplied from the camera body 200 to the interchangeable lens 100 and the sum of the upper limit values of the power of the image stabilizing actuator 110 and the focus actuator 112, is distributed to other operation units in the interchangeable lens 100 and the adapter 300. Thus, the interchangeable lens 100 and the adapter 300 can effectively utilize power without increasing the power supply amount from the camera body 200 to the interchangeable lens 100. More specifically, in a case where the output torque required for the actuator increases at low temperatures or in a case where the required power increases to improve the actuator performance (e.g., speed), surplus power is allocated to them.

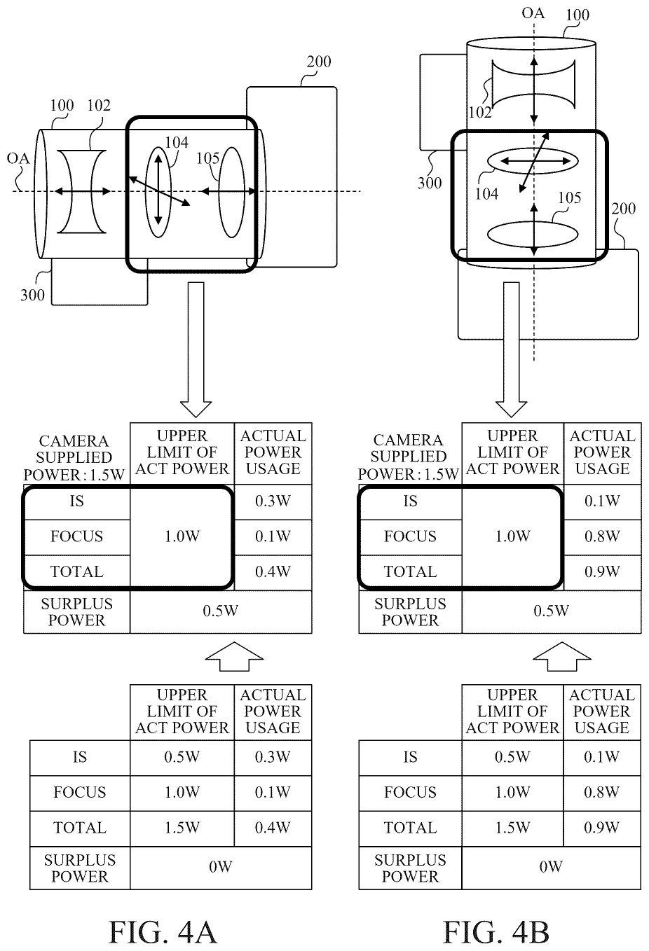

FIGS. 4A and 4B each illustrate an example of setting the total upper limit values of the power for the image stabilizing actuator 110 and the focus actuator 112 in the horizontal and vertical orientations in a comparative example with respect to the present invention. The lower part of FIGS. 4A and 4B illustrate an example of the upper limit values of the power and the total value for the image stabilizing actuator 110 and the focus actuator 112 in the horizontal and vertical orientations illustrated in FIGS. 3A and 3B. FIGS. 4A and 4B also illustrate an example of the actual power usage and the total value for the image stabilizing actuator 110 and the focus actuator 112, similarly to FIG. 3A and 3B. Here, the power supply from the camera body 200 is set to 1.5 W.

The comparative example sets the total value of upper limit values of the power for the horizontal and vertical orientations to 1.0 W based on the total value of 0.9 W in the vertical orientation, where the total value of the actual power usages by the image stabilizing actuator 110 and the focus actuator 112 is greater than that of the horizontal orientation. In this case, in the horizontal orientation, for example, the upper limit value of the power for the image stabilizing actuator 110 may be set to 0.5 W, and the upper limit value of the power for the focus actuator 112 may be set to 0.5 W. In the vertical orientation, for example, the upper limit value of the power for the image stabilizing actuator 110 may be set to 0.2 W, and the upper limit value of the power for the focus actuator 112 may be set to 0.8 W.

By setting the upper limit value of the power in this manner, surplus power of 0.5 W is secured in both the horizontal and vertical orientations, which is a difference between the supplied power of 1.5 W from the camera body 200 and the total value of 1.0 W of the upper limit values of the power. In the horizontal orientation, the total value of the upper limit values of the power is set to 1.0 W, which is large compared to the total value of the actual power usage of 0.4 W, and a difference of 0.6 W between them cannot be effectively utilized. In other words, although there is still a margin of 0.6 W, only 0.5 W can be secured as surplus power.

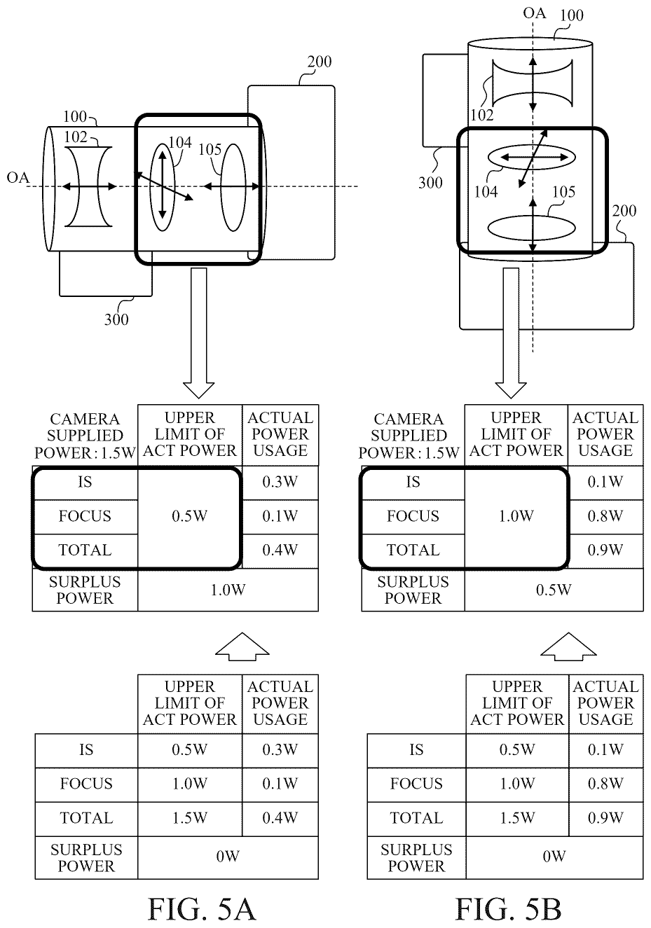

FIGS. 5A and 5B illustrate setting examples of the total value of the upper values of the power for the image stabilizing actuator 110 and the focus actuator 112 in the horizontal orientation and the vertical orientation in the present embodiment. The lower part in FIGS. 5A and 5B illustrates examples of the upper limits of the power and the total value for the image stabilizing actuator 110 and the focus actuator 112 in the horizontal orientation and the vertical orientation illustrated in FIGS. 3A and 3B. FIGS. 5A and 5B also illustrate examples of the actual power usage for the image stabilizing actuator 110 and the focus actuator 112 and the total value of the upper limit values of the power, as in FIGS. 3A and 3B. Here, the supplied power from the camera body 200 is set to 1.5 W.

For the horizontal orientation illustrated in FIG. 5A, the total value of the upper limit values is set to 0.5 W based on the total value of 0.4 W of actual power consumption of the image stabilizing actuator 110 and the focus actuator 112. For the vertical orientation illustrated in FIG. 5B, the total value of the upper limit values is set to 1.0 W based on the total value of 0.9 W of actual power consumption of the image stabilizing actuator 110 and the focus actuator 112. In this case, for example, for the horizontal orientation, the upper limit value of the power for the image stabilizing actuator 110 may be set to 0.3 W and the upper limit value of the power for the focus actuator 112 may be set to 0.2 W. For the vertical orientation, the upper limit value of the power for the image stabilizing actuator 110 may be set to 0.2 W and the upper limit value of the power for the focus actuator 112 may be set to 0.8 W.

By setting the upper limit value of the power in this way, surplus power of 1.0 W is secured for the horizontal orientation, which is a difference between the supplied power of 1.5 W from the camera body 200 and the total value of 0.5 W of the upper limit values of the power. Surplus power of 0.5 W is secured for the vertical orientation, which is a difference between the supplied power of 1.5 W from the camera body 200 and the total value of 1.0 W of the upper limit values of the power. In other words, the surplus power can be more efficiently allocated in comparison with the settings of the upper limit values of the power illustrated in FIGS. 4A and 4B.

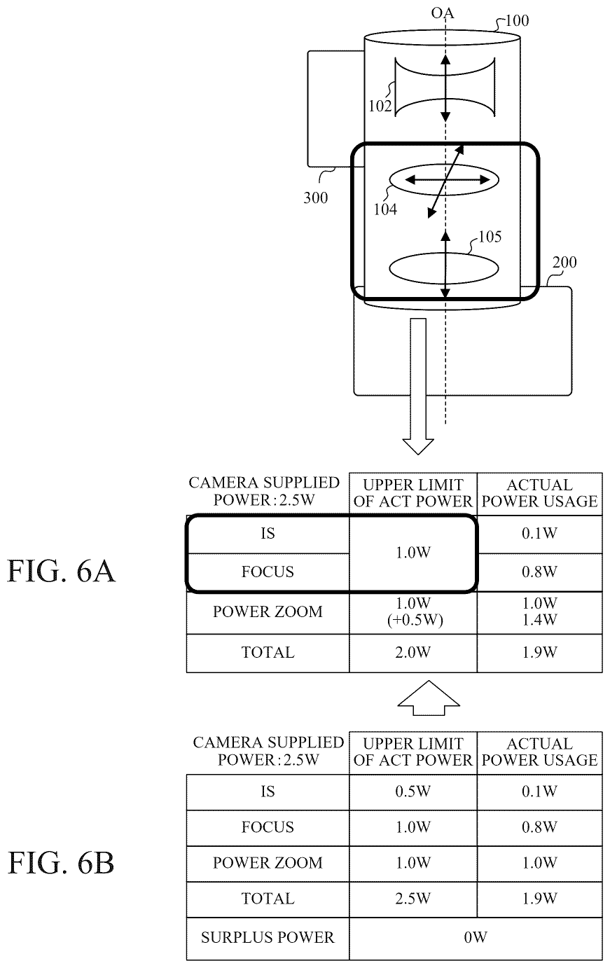

FIG. 6A illustrates an example of the upper limit values of the power and actual power usages for the image stabilizing, focus, and zoom actuators 110, 112, and 311 in a case where the surplus power secured in the vertical orientation by the setting of the upper limit value of the power in FIG. 4B or 5B is allocated to driving the zoom actuator 311 in the adapter 300. FIG. 6B illustrates an example of the upper limit values of the power and actual power usages for the image stabilizing, focus, and zoom actuators 110, 112, and 311 in a case where the upper limit value of the power is set as illustrated in FIG. 3B. Here, the supplied power from the camera body 200 is set to 2.5 W.

In the vertical orientation (upward orientation), the magnification-varying lens 102 is driven against gravity in the upward direction in the optical axis direction, so the output torque required for the zoom actuator 311 increases, and a larger actual power consumption is required than that in the horizontal orientation. As illustrated in FIG. 6A, the normal actual power consumption of the zoom actuator 311 in the vertical orientation is, for example, 1.0 W, and the upper limit value of the power is set to 1.0 W.

Adding the surplus power of 0.5 W secured by the interchangeable lens 100 to the upper limit value of the power for the zoom actuator 311 can increase that upper limit value of the power to 1.5 W. Thus, even if the actual power usage increases, for example, to 1.4 W by driving the zoom actuator 311 at a higher speed than normal, the zoom actuator 311 can be satisfactorily driven. In a case where the environmental temperature rises from room temperature to a high temperature, friction increases due to hardening of grease in the interchangeable lens 100 and the adapter 300 and expansion of parts, and the actual power usage may increase from that at room temperature. Even in this case, the zoom actuator 311 can be satisfactorily driven as long as the actual power usage does not exceed 1.5 W.

Thus, distributing the surplus power secured by the interchangeable lens 100 to the adapter 300 can maintain or improve the zoom drive performance of the adapter 300 without increasing the supplied power from the camera body 200.

In FIG. 6B, the surplus power is not secured by the interchangeable lens 100, so the upper limit value of the power of the zoom actuator 311 is 1.0 W. Thus, the zoom actuator 311 may not be driven at a sufficiently high speed or may not be driven satisfactorily at high temperatures.

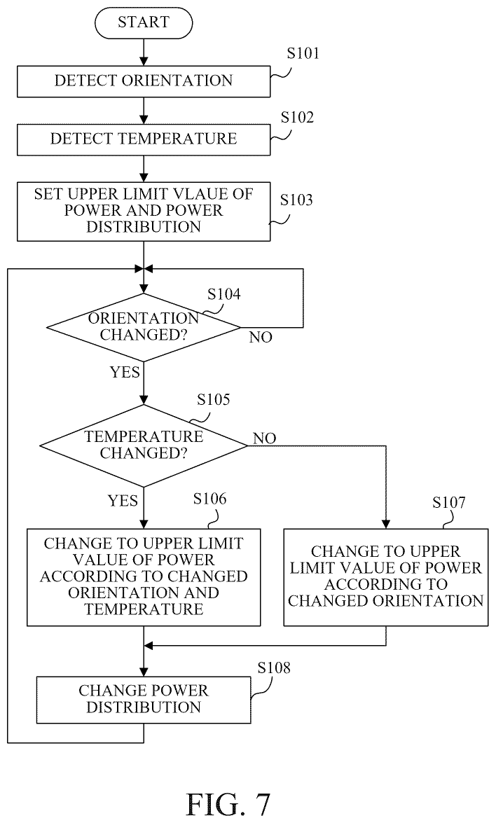

A flowchart in FIG. 7 illustrates processing of setting an upper limit value of the power (control method) executed by the lens CPU 114 (power upper-limit setting unit 122) executing a program.

In step S101, the lens CPU 114 detects (acquires) the orientation through the orientation detector 123.

Next, in step S102, the lens CPU 114 acquires via communication the temperature detected by the temperature sensor 314 in the adapter 300. The orientation detector and temperature sensor may be provided in the interchangeable lens 100, the camera body 200, or the adapter 300, as long as the lens CPU 114 can acquire the detected orientation and temperature.

Next, in step S103, the lens CPU 114 sets the total value of the upper limit values of the power for the image stabilizing actuator 110 and the focus actuator 112 and the upper limit value of the power for each actuator based on the orientation detection result and temperature detection result acquired in steps S101 and S102. At this time, in a case where the adapter 300 is attached to the interchangeable lens 100, the upper limit value of the power of the zoom actuator 311 may be set. The setting of the specific upper limit value of the power is as described with reference to FIGS. 5A, 5B, and 6A. More specifically, table data indicating the upper limit values of the power corresponding to the orientation and temperature have been previously prepared. Then, the upper limit value of the power corresponding to the acquired orientation and temperature is read out of the table data and set. The upper limit value of the power corresponding to the orientation in the table data may include values corresponding to the horizontal orientation and vertical orientation as well as values corresponding to one or more intermediate orientations between the horizontal orientation and the vertical orientation (such as a diagonally upward orientation). The upper limit value of the power corresponding to the intermediate orientation may be calculated by an interpolation calculation using the upper limit values of the power corresponding to the horizontal orientation and the vertical orientation.

In a case where there is surplus power as a difference between the total value of the set upper limit values of the power and the supplied power from the camera body 200, the lens CPU 114 sets the allocation of the surplus power (such as allocation to the adapter 300).

Next, in step S104, the lens CPU 114 determines whether the orientation acquired through the orientation detector 123 has changed. In a case where the orientation has changed, the processing of step S106 is performed. In a case where the orientation has not changed, the determination of step S104 is repeated.

In step S105, the lens CPU 114 determines whether the temperature acquired from the adapter 300 has changed. In a case where the temperature has changed, the processing of step S106 is performed. In a case where the temperature has not changed, the processing of step S107 is performed.

In step S106, the lens CPU 114 changes the upper limit value of the power set in step S103 to an upper limit value of the power corresponding to the changed orientation and temperature. Then, the lens CPU 114 performs the processing of step S108.

In step S107, the lens CPU 114 changes the upper limit value of the power set in step S103 to an upper limit value of the power based on the changed orientation. Then, the processing of step S108 is performed.

In step S108, the lens CPU 114 sets the allocation of surplus power, which is a difference between the total value of the upper limit values of the power changed in step S106 or S107 and the supplied power from the camera body 200. Then, the determination of step S04 is performed again.

As described above, in the interchangeable lens 100 according to the present embodiment, the upper limit values of the power and the allocation of surplus power for the image stabilizing actuator 110 and the focus actuator 112 are properly set based on the orientation and temperature. Thus, the interchangeable lens 100 and the adapter 300 can effectively utilize the limited power supplied from the camera body 200.

The present embodiment sets the upper limit values of the power for the image stabilizing actuator 110 and the focus actuator 112. As long as the actual power usage of one of the two actuators increases and the actual power usage of the other decreases based on the orientation change, the upper limit value of the power may be set and the surplus power allocation may be set for any actuator. As described above, in a case where power is supplied to the interchangeable lens 100 from an external power source other than the camera body 200, the surplus power may be generated by setting a total value of the supplied power from the camera body 200 and the external power source or the upper limit value of the power for the supplied power only from the external power source.

The surplus power secured in the interchangeable lens 100 may be distributed to the camera body 200 without distributing it to another operation unit other than the image stabilizing actuator 110 and the focus actuator 112 in the interchangeable lens 100 or the adapter 300. More specifically, the lens CPU 114 may transmit information about the surplus power to the camera CPU 206, so that the camera CPU 206 can select high-resolution imaging that uses more power or can increase the frame rate. An imaging mode that requires more power may be added to the types of selectable imaging modes.

The processing for setting the upper limit value of the power as described above may be performed in an adapter that receives power from at least one of an interchangeable lens and an external power source to drive the first and second drive units.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an accessory that can effectively utilize limited power.

This application claims priority to Japanese Patent Application No. 2024-105942, which was filed on Jul. 1, 2024, and which is hereby incorporated by reference herein in its entirety.

What is claimed is:

1. An accessory for use with an image pickup apparatus, the accessory comprising:
a first drive unit configured to move a first movable member;
a second drive unit configured to move a second movable member;
one or more memories storing instructions; and
one or more processors that, upon execution of the instructions, operate to control power used for driving the first drive unit and the second drive unit,
wherein in a case where an orientation of the accessory changes from a first orientation to a second orientation, power used for driving one of the first drive unit or the second drive unit increases while power used for driving the other of the first drive unit or the second drive unit decreases, and
wherein the one or more processors operate to change an upper limit value of the power used for driving the first drive unit and the second drive unit based on the orientation of the accessory.

2. The accessory according to claim 1, wherein a total value of the power used for driving the first drive unit and the second drive unit changes based on a change in the orientation.

3. The accessory according to claim 1, wherein the first drive unit drives the first movable member in a first direction, and wherein the second drive unit drives the second movable member in a second direction orthogonal to the first direction.

4. The accessory according to claim 1, wherein the one or more processors operate to change the upper limit of the power used for driving the first drive unit and the second drive unit.

5. The accessory according to claim 1, wherein the one or more processors operate to change the upper limit as a total value for the first drive unit and the second drive unit based on a detection result of the orientation.

6. The accessory according to claim 1, wherein the one or more processors operate to change the upper limit value based on a detected temperature.

7. The accessory according to claim 1, wherein the one or more processors operate to allocate surplus power generated by lowering the upper limit of power supplied from at least one of the image pickup apparatus or an external power source as power used by another member in the accessory different from the first drive unit and the second drive unit.

8. The accessory according to claim 1, wherein in a case where another accessory is attached to the accessory, the one or more processors operate to supply surplus power generated by lowering the upper limit value for power supplied from at least one of the image pickup apparatus or an external power source to the another accessory.

9. The accessory according to claim 1, wherein the accessory is at least one of a lens apparatus attachable to and detachable from the image pickup apparatus or an adaptor attachable to and detachable from the lens apparatus.

10. A method for an accessory, for use with an image pickup apparatus, including a first drive unit configured to drive a first movable member and a second drive unit configured to drive a second movable member, the method comprising:
acquiring an orientation of the accessory;
in a case where the orientation of the accessory changes from a first orientation to a second orientation, increasing power to be used for driving one of the first drive unit or the second drive unit and increasing power used for driving the other of the first drive unit or second drive unit; and
changing an upper limit value of the power used for driving the first drive unit and the second drive unit based on the orientation.

11. A non-transitory computer-readable storage medium storing a program that causes a computer to execute the method according to claim 10.
